(19) United States
(12) Patent Application Publication
(10) Pub. No.: US 2016/0014110 A1
(43) Pub. Date: Jan. 14, 2016

(54) SECURITY SYSTEMS AND METHODS

(71) Applicant: PERSONAL, INC., Washington, DC (US)

(72) Inventor: Tarik KURSPAHIC, Washington, DC (US)

(21) Appl. No.: 14/768,762

(22) PCT Filed: Feb. 21, 2013
(86) PCT No.: PCT/US2013/027133

§ 371 Date: Aug. 19, 2015

(51) Int. Cl. H04L 29/06; G06F 21/31

(52) U.S. Cl. CPC H04L 63/083; G06F 21/31; H04L 63/0435; H04L 63/10

(57) ABSTRACT

Systems, methods, and tangible computer-readable storage mediums for providing secure access to information during a user session are provided. A password from a user device can be received via a network. An encryption key and a decryption key can be generated. The password can be encrypted using the encryption key. The decryption key can be encrypted. A first combination of a portion of the encrypted decryption key and a portion of the encrypted password can be generated. A second combination of a remaining portion of the encrypted decryption key and a remaining portion of the encrypted password can be generated. The first combination can be transmitted and stored in the user session, and the second combination can be stored in a database.

### SUMMARY

Aspects of the systems, methods, and tangible computer-readable storage media as well as computer programs for providing secure access to information are described herein. Embodiments of the present disclosure relate to a secure system for storing information that may be sensitive, for example, personally identifying information about a particular user. One goal of such a system is to retain the information for the authorized user, and allow access to the information by the authorized user, in a manner which lowers the risk that the sensitive information can be improperly accessed by any person. To that end, embodiments of the present disclosure can employ a novel system of encryption to provide a high level of information security for system users, while increasing the efficiency and speed of underlying computer systems, resulting in a tangible and concrete technical benefit to operators and users of the system. The novel system of encryption lowers the risk that access information (such as passwords, encryption keys, etc.) can be intercepted or retrieved in an unauthorized manner, and thereby lowers the risk that sensitive information could be improperly exposed.

Sensitive information, such as confidential, personal information, can be encrypted. Passwords can also be encrypted. The sensitive information and passwords can be encrypted using an encryption key, and decrypted using a decryption key. In a symmetric encryption system, the same key can be used for both encryption and decryption. In an asymmetric encryption system, an encryption key can be used to encrypt information, which then requires a different key for decryption.

In an example secure storage system, a user might log on (possibly remotely, through a Web or other interface) to the system. The log-on process is accomplished by providing identifying and/or authenticating information, such as a username and a password. This begins a session, or a series of relatively time-contiguous transactions and/or communications between the user and the system (note that, as used herein, a “user session” refers to data relating to these transactions and/or communications stored by the user's device). In order to protect the user's sensitive information on the system, the sensitive information can be encrypted using the user's access information (e.g. password) in the encryption process. However, if the password is also stored on the system, this might expose the sensitive information to risk of disclosure, should an unauthorized intruder gain access to the system. To lower that risk, the system might discard the access information, thus requiring the user to re-enter the access information each time access to sensitive information is required. This, however, may cause inconvenience to the user.

The systems and methods described herein provide efficient and secure access to sensitive information. In some embodiments, a system is provided such that the user may only be required to provide password at the beginning of a user session. In so increasing the convenience to the user, the security of the system is also increased. For example, a user session may start when the user logs into a web site, for instance, to access sensitive information. In one embodiment, after the user's identity is verified (e.g., a hash of the user's password matches a stored password hash), an asymmetric encryption key-decryption key pair may be randomly generated. The user's password may be encrypted using the encryption key (e.g. a public key). After this step, both the unencrypted password and encryption key may be discarded permanently and securely from the system. In one embodiment, the corresponding asymmetric decryption key may also be encrypted (e.g., through a separate, symmetric encryption process), and the unencrypted decryption key may be discarded permanently from the system after this step.

The system may break the encrypted password and the encrypted decryption key into portions, and generate combinations of portions of the encrypted password and portions of the encrypted decryption key. For example, the system may break the encrypted password and the encrypted decryption key in their middles, and generate a combination of the first half of the encrypted password and the first half of the encrypted decryption key. The system may generate another combination of the second half of the encrypted password and the second half of the encrypted decryption key. In one embodiment, the system may transmit the combination of either the first half of the encrypted password and the first half of the encrypted decryption key or the second half of the encrypted password and the second half of the encrypted decryption key to the user device, storing it, e.g., in a session cookie. This transmission can itself be encrypted, for example, using secure sockets. The respective other combination may be stored in a database on the server side (e.g., if the respective first halves are transmitted, then the second half of the encrypted password and the second half of the encrypted decryption key would be stored). In the embodiments described above, the user's password may only be stored on the server side for a brief duration (e.g., between the time when password is received and the encrypted password is generated) and may be discarded permanently and securely, thereby ensuring secure protection of the user's password, even from unauthorized users of the secure storage system.

In some embodiments, after logging in and also during the user session, if the user wishes to access sensitive information, no password is required to be entered. For example, in one embodiment, when the user wishes to access sensitive information that has been encrypted using the user's password, a request may be sent from the user device to the server. The request may include the combination of the one half of the encrypted password and the one half of the encrypted decryption key. The system (e.g., the server) may obtain the combination of the respective other half of the encrypted password and the respective other half of the encrypted decryption key from the system database. In one embodiment, the system may then restore the encrypted password and the encrypted decryption key based on the two combinations. The system may decrypt the encrypted decryption key using the symmetric key, and use the decryption key to decrypt the encrypted password. With the password restored, the system may access the confidential information using the password as if it is entered by the user. Once the sensitive information is accessed, the password is discarded permanently and securely from the server. Because neither the entire encrypted password nor the entire encrypted decryption key is permanently stored on the system or in a session cookie, and also because only portions of the encrypted password and the encrypted decryption key are transmitted over a network during subsequent communications, system security is improved.

Thus, the systems and methods described herein can provide secure and efficient access to sensitive information. In preferred embodiments the user only needs to enter the password once per session, for example, at log in. Neither the password nor the decryption key are present on the server side other than for the brief duration between the time when a request to access sensitive information is received and the time when the need to use the decryption key and passwords has passed. Furthermore, because the encryption and decryption keys are randomly generated, the signatures (for the system and user session) are different for every user session and rotate quickly with sessions.

One aspect of an exemplary embodiment is directed to a computer-implemented method of providing secure access to information during a user session. The method includes receiving, by one or more processing circuits, a password from a user device via a network. The method includes generating, by the one or more processing circuits, an encryption key and a decryption key. The method also includes generating an encrypted password by encrypting the password using the encryption key, and generating an encrypted decryption key by encrypting the decryption key. The method further includes generating a first combination of a portion of the encrypted decryption key and a portion of the encrypted password. The method additionally includes generating a second combination of a remaining portion of the encrypted decryption key and a remaining portion of the encrypted password. The method includes transmitting the first combination, and storing the second combination in a database.

Another aspect of an exemplary embodiment is directed to a system of providing secure access to information during a user session. The system includes memory hardware storing program instructions, and one or more processors in data communication with the memory hardware and configured to execute the program instructions, and upon execution the program instructions causing the one or more processors to perform operations including receiving a password from a user device via a network. The operations include generating an encryption key and a decryption key. The operations also include generating an encrypted password by encrypting the password using the encryption key, and generating an encrypted decryption key by encrypting the decryption key. The operations further include generating a first combination of a portion of the encrypted decryption key and a portion of the encrypted password. The operations additionally include generating a second combination of a remaining portion of the encrypted decryption key and a remaining portion of the encrypted password. The operations include transmitting the first combination, and storing the second combination in a database.

Another aspect of an exemplary embodiment is directed to a non-transitory computer readable medium having machine instructions stored therein, the instructions being executable by one or more processors to cause the one or more processors to perform operations. The operations include receiving a password from a user device via a network. The operations include generating an encryption key and a decryption key. The operations also include generating an encrypted password by encrypting the password using the encryption key, and generating an encrypted decryption key by encrypting the decryption key. The operations further include generating a first combination of a portion of the encrypted decryption key and a portion of the encrypted password. The operations additionally include generating a second combination of a remaining portion of the encrypted decryption key and a remaining portion of the encrypted password. The operations include transmitting the first combination, and storing the second combination in a database.

### BRIEF DESCRIPTION OF THE DRAWINGS

The accompanying drawings are not intended to be drawn to scale. Various embodiments taught herein are illustrated by way of example, and not by way of limitation, in the figures of the accompanying drawings, in which:

FIG. 1 is a block diagram illustrating an example system for providing secure access to information during a user session, according to an exemplary embodiment;

FIG. 2A is a block diagram illustrating an example of a password encryption and secured storage process, according to an exemplary embodiment;

FIG. 2B is a block diagram illustrating an example of a password secured retrieval and decryption process, according to an exemplary embodiment;

FIG. 3 is a flow diagram illustrating a process according to an exemplary embodiment, such that a password is encrypted and securely stored during a user session;

FIG. 4 is a flow diagram illustrating a process according to an exemplary embodiment, such that a password is securely retrieved and decrypted during a user session; and

FIG. 5 is a block diagram illustrating a computer system that may be employed to implement the systems and methods of providing secure access to information during a user session, according to an exemplary embodiment.

### DETAILED DESCRIPTION

The systems, methods, and tangible computer-readable storage medium and computer programs of the present disclosure provide secure and efficient access to information. Such methods are envisioned to be carried out on a computer system, which may comprise one or more integrated circuits or other processors that may be programmable or special-purpose devices. The system can comprise memory which may be one or more devices, which may be persistent or non-persistent, such as dynamic or static random access memories, flash memories, electronically erasable programmable memories, or the like, having instructions embedded therein, such that if executed by a programmable device, the instructions will carry out methods as described herein to form systems and devices having functions as described herein. When carried out as described herein, the systems, methods and tangible, computer-readable storage media and computer programs of the present application increase the efficiency and speed and security of the underlying computer system, resulting in a tangible and concrete technical benefit to a system operator, while providing a high level of information security to a user.

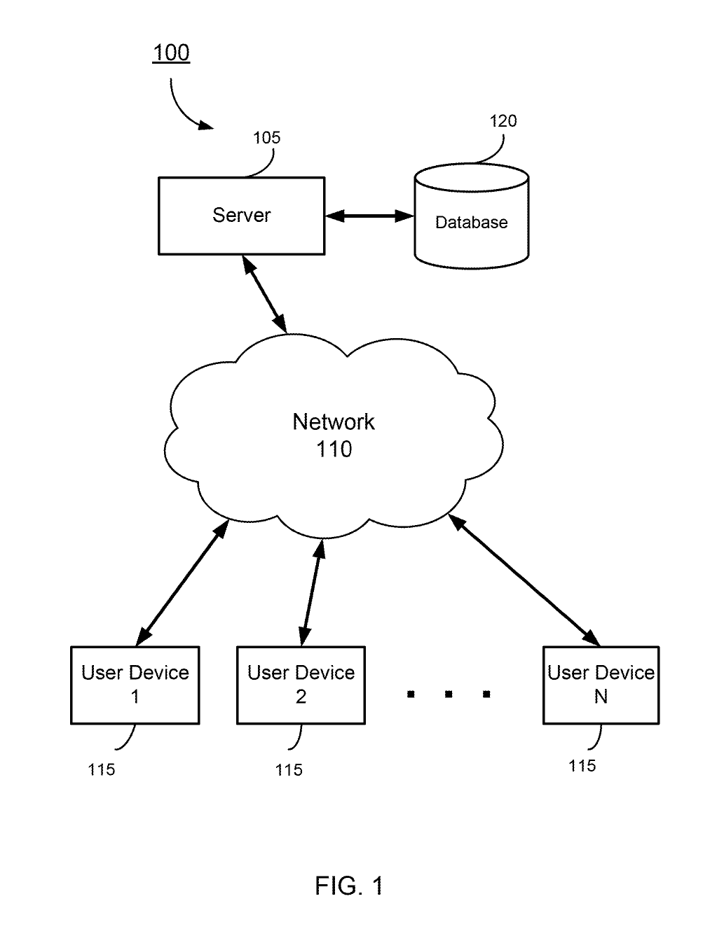

FIG. 1 illustrates an example system 100 for providing secure access to information during a user session. As shown in FIG. 1, an exemplary networked system 100 for implementing process(es) according to embodiments of the present disclosure may include, but is not limited to, a computing device 105 that communicates with user devices 115 via a network 110. The network 110 can include, but not limited to, computer networks such as the Internet, intranets, local, wide, metro, cellular communication networks, Wi-Fi network (according to any of the IEEE 802.11 standards), a Wi-Max network (according to any of the IEEE 802.16 standards), personal area networks (e.g., a Bluetooth network or infrared network), or other networks.

The computing device 105 may be a server 105 that communicates with user devices 115 via the network 110. The user device 115 can include, but not limited to, workstation computers, laptops, desktops, smart phones, tablets, personal digital assistants, server devices, any special-purpose computers, and the like. In some embodiments, user devices 115 may communicate with server 105 through a web site. The user devices 115 may be mobile devices and the web site may be a mobile web site, intended to be accessed through mobile devices. The user devices 115 may communicate with server 105 through one or more applications comprising computer-executable instructions. Alternative embodiments may not involve a network at all, and may instead be implemented on a standalone device 105 used by the user(s).

The server 105 may be implemented as a network of computer processors. In some embodiments, the server may be multiple servers, mainframe computers, networked computers, a processor-based device, or a similar type of system or device. In some embodiments, the server 105 may be a server farm or data center. The server 105 may receive connections through a load-balancing server or servers. In some embodiments, a task may be divided among multiple servers 105 that are working together cooperatively. The system 100 may also include a database 120 which can communicate with server 105. In one embodiment, database 120 may be a separate device from server 105. In other embodiments, database 120 may be considered as one device with server 105. The database 120 may contain sensitive information which the systems and methods described herein providing secure access to.

In one embodiment, a password can be received from a user device via the network. For example, the server 105 can be configured to receive the password from the user device 115 via the network 110. In one embodiment, the user device 115 may execute a web browser application and send, for example, a Hypertext Transfer Protocol (HTTP) request or a Hypertext Transfer Protocol Secure (HTTPS) request to the server 105 for accessing information stored in a database that the server 105 can access, such as the database 120. The server 105 may receive the request and send a response back to the user device 115. For example, a log in screen may be displayed in the web browser of the user device 115, prompting the user of the user device 115 to enter a user name and a password. The user may provide a username, such as a string, an email address, or an equivalent. The user may also provide a password, such as a string, or a fingerprint, or an equivalent. In some embodiments, a password may be created for the user. The password may be a combination of letters, digits, and/or special characters with a minimum number (e.g., eight) of characters. In one embodiment, the password may be provided by the user in plain text, and may be transmitted to the server 105 in plain text. In another embodiment, the password may be encrypted for transport to the server 105.

In some embodiments, a notification to begin a user session may be received. For example, the server 105 may be configured to receive a notification to begin a user session from the user device 115. The notification may include a session ID. In one embodiment, the server 105 may receive the notification to begin a user session when the server 105 receives the HTTPS request from the user device 115 via the network 110. For example, the user device 115 may initiate a HTTP request by establishing a Transmission Control Protocol (TCP) connection via the network 110 to a port on the server 105. The server 105 may listen on the port waiting for client's request messages. Upon receiving the request, the server 105 may send certain information (e.g., an acknowledge message, a status and a message) to the user device 115. In one embodiment, the user session may begin when the user device 115 receives the server 105's response. In another embodiment, the user session may begin after the server 105 verifies the password provided by the user device 115.

In some embodiments, a hash of the password may be verified to match a stored password hash. For example, the server 105 may be configured to verify that a hash of the password matches a password hash stored in the database 120. A password hash may be a one-way encryption or transformation of a password. Examples of hash algorithms include SHA-2, SHA-3, WHIRLPOOL, and others. The password hash may be augmented by a salt value or other value. This has the benefit of increasing the cryptographic strength of the hash. The password or equivalent may be stored, or it may not be stored if the hash is stored instead. In some embodiments, when a user logs in, the user provides a password, and a hash may be taken over the provided password. This hash may be compared to a stored hash. If they are the same, the log-in may succeed. If they are not the same, the log-in may fail.

Non-transiently storing the hash of a password, but not the password itself, is beneficial because it maintains security while reducing the likelihood that information can be accessed if a hash is stolen. If an unencrypted password is found by an intruder or hacker to server 105, then it can be used to log in to the user's account, so that the intruder has access to everything accessible by the account. However, if the hash is found by the intruder, then it likely cannot be used to successfully log in. (Attempting to log in using the hash would cause a new hash to be taken over the original one, which would be highly unlikely to match the stored, original hash.)

In one embodiment, the password received from the user may be stored non-transiently. For example, the password may be stored non-transiently in the database 120 which, as described previously, can be an external database to the server 105 or can be part of the server 105. In another embodiment, the password may be stored transiently, such as in the random-access memory (RAM) of the server 105. In one embodiment, the password may be discarded after a certain time period or after the occurrence of a certain event, as described later in the disclosure.

In one embodiment, an encryption key and a decryption key can be generated. For example, the server 105 (e.g., a processor of the server 105) can be configured to generate an encryption key and a decryption key using an encryption algorithm. An encryption key is a key used to encrypt information, such as a message or the password provided by the user. A decryption key is a key used to decrypt the information. The encryption key and the decryption can be the same if symmetric encryption is used, or can be different if asymmetric encryption is used.

Encryption can be a mechanism or process by which information or message is encoded such that only authorized parties can read it. Various encryption algorithms have been developed. For example, symmetric encryption algorithms may include, but are not limited to, AES (such as AES 256 bit), Blowfish, DES, Triple DES, Serpent, Twofish, and the like. Asymmetric encryption algorithms may include, but are not limited to, RSA (such as RSA 2048-bit), ElGamal, Diffie-Hellman, Cramer-Shoup, and the like. Key pair(s) may be used for asymmetric encryption. An asymmetric key pair may include a public key and a private key, which are different, but mathematically related, keys. The public key may be used for encryption such that only the holder of the private key may decrypt what was encrypted. This is beneficial because it allows encryption and decryption without requiring a secure exchange of keys.

In one embodiment, the encryption key and the decryption key can be generated randomly. For example, the encryption key and the decryption key can be generated randomly using an encryption algorithm, such as the RSA 2048-bit asymmetrical algorithm. In one embodiment, a Random Number Generators (RNG) or a

Pseudo-Random Number Generators (PRNG) can be used to ensure the composition of the key is random. Randomly generated keys have advantages, for example, it would be more difficult for unauthorized persons to guess randomly generated keys than non-randomly generated keys. For example, in the systems and methods described herein, signatures (e.g., on server and user session) can be different for every user session and rotate quickly with user sessions.

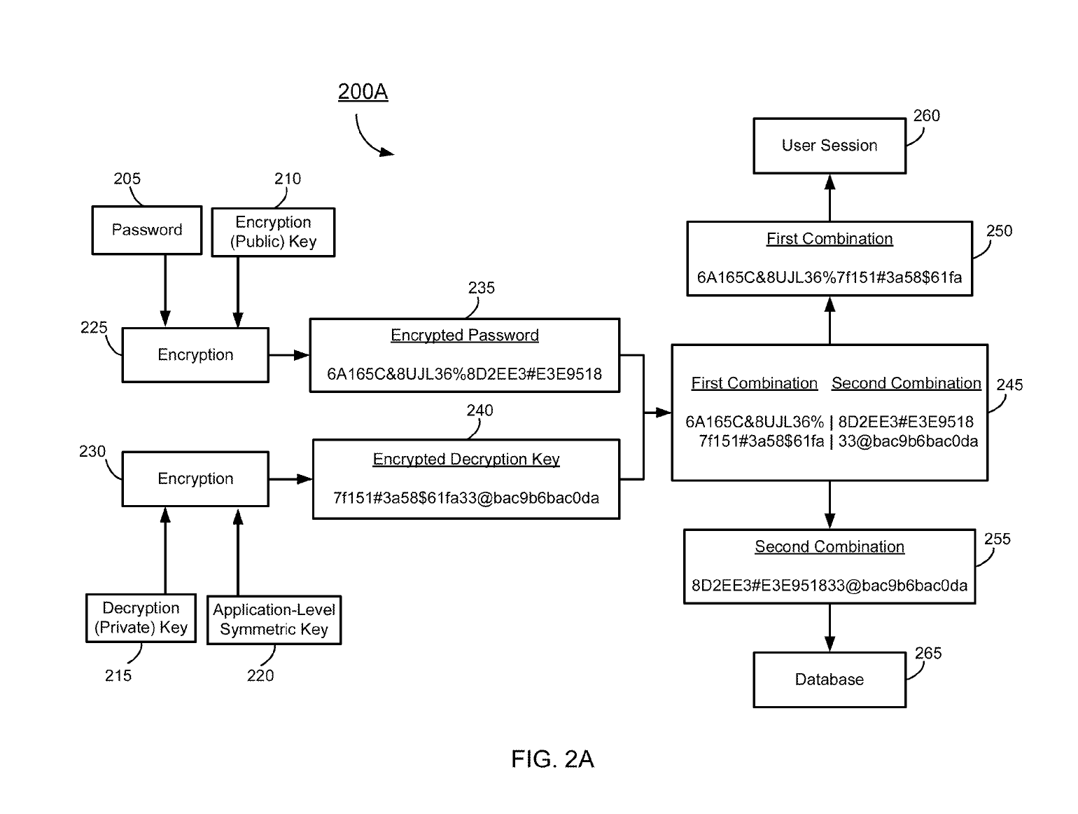

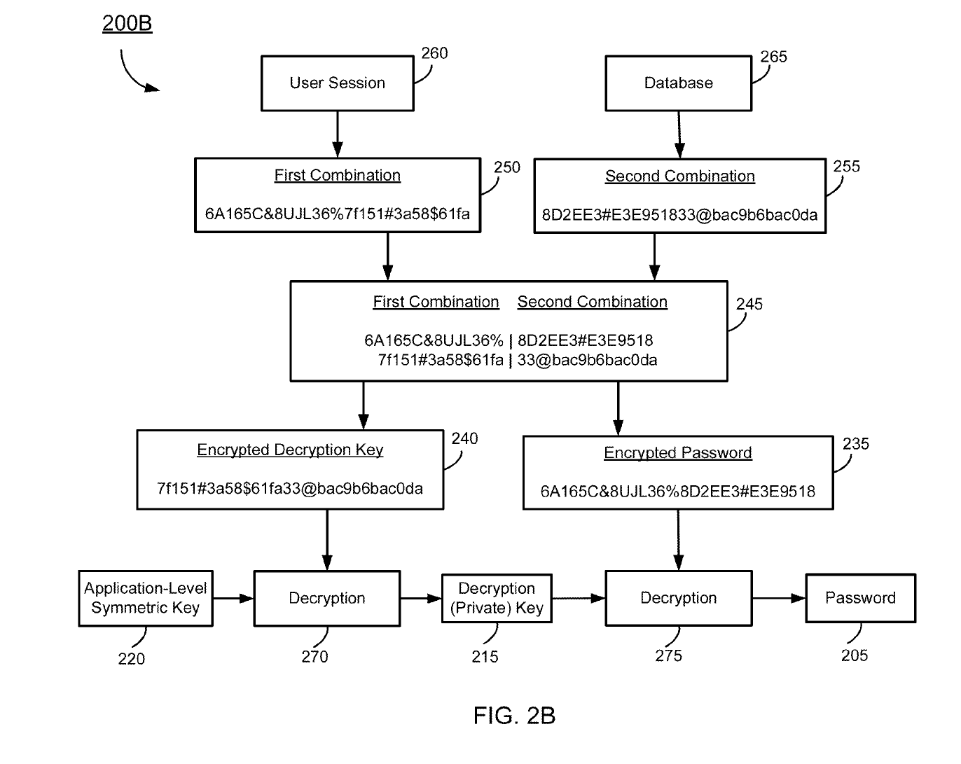

FIG. 2A is a block diagram depicting an example of a password encryption and secured storage process. Referring to FIG. 1 and FIG. 2A, in some embodiments, an encrypted password can be generated by encrypting the password using the encryption key. For example, the server 105 (e.g., a processor of the server 105) can be configured to encrypt the password using the encryption (public) key in the key pair, and generate the encrypted password. In one embodiment, the RSA 2048-bit asymmetrical algorithm can be used to encrypt the password using the encryption key. For example, as shown in FIG. 2A, the password 205 and the encryption (public) key 210 can be input into the encryption algorithm 225 (e.g., the RSA 2048-bit asymmetrical algorithm), and an encrypted password 235 can be generated. The value of the encrypted password 235 in FIG. 2A is for illustration purposes only and does not represent the key size, etc. Shorter, longer, different values, and/or values in different formats can be generated depending on implementations.

In some embodiments, the unencrypted password 205 can be discarded. For example, the server 105 can be configured to discard the unencrypted password 205. In one embodiment, the unencrypted password 205 can be discarded after the encrypted password 235 is generated. Discarding the password once the encrypted password is generated can keep the password at the server 105 for only a short duration, thereby increasing the protection of the user's password and sensitive information. In one embodiment, a timeout value may be set for discarding the password such that the password can be discarded after a certain time period. For example, if the password is not successfully encrypted (not discarded after the encrypted password is generated), or if the server 105 crashes before the password is discarded, the systems and methods described herein can ensure the password is still discarded. In one embodiment, if the server 105 crashes before the password is discarded, the timeout value can ensure the password is discarded after the server 105 reboots. The timeout value can be implementation-dependent, for example, 200 milliseconds, 1 second, or any other suitable time period, longer than the estimated maximum time required to generate the encrypted password. The timeout value may be determined based on various factors, such as the processor speed and the complexity of the encryption algorithm used to encrypt the password.

“Discarding” password or other information in the systems and methods described herein can mean securely erasing the information, not just marking the information for deletion or marking the information as deleted in a block allocation map. For example, the server 105 may write all zeros to the memory block that stores the password, and may go further for certain media by overwriting with random or pseudorandom data a specified number of times. By erasing information this way, the systems and methods described herein may ensure that sensitive information (e.g., the password) is permanently deleted from the system, thereby unauthorized users (e.g., hackers) may not be able to obtain the information.

In one embodiment, an encrypted decryption key can be generated by encrypting the decryption key. For example, the server 105 can be configured to encrypt the private key in the key pair generated by the encryption algorithm. In one embodiment, an application-level symmetric key and a symmetric key encryption algorithm can be used to encrypt the decryption key. For example, an application-level symmetric key can be a symmetric key defined or generated by the server 105 or supplied by the user device 115 or other devices. In one embodiment, the symmetric key encryption algorithm can be the PBEWITHSHA-1AND256BITAES-CBC-BC algorithm. For example, as shown in FIG. 2A, the decryption (private) key 215 and the application-level symmetric key 220 can be inputted into the encryption algorithm 230 (e.g., the PBEWITHSHA-1AND256BITAES-CBC-BC algorithm), and an encrypted decryption key 240 can be generated. The value of the encrypted decryption key 240 in FIG. 2A is for illustration purposes only and does not represent the key size or anything. Shorter, longer, different values, and/or values in different formats can be generated depending on implementations.

In one embodiment, a first combination of a portion of the encrypted decryption key and a portion of the encrypted password can be generated. For example, the server 105 can be configured to generate a combination which consists of a portion of the encrypted decryption key and a portion of the encrypted password. In one embodiment, the portion of the encrypted decryption key can be of half length of the encrypted decryption key, and the portion of the encrypted password can be of half length of the encrypted password. A half-length, can be, for instance, half of the total number of bits, characters or numerals in the encrypted decryption key or the encrypted password. If the total number of bits, characters or numerals is an odd number (e.g., n+1, where n is an even number), the portion of the encrypted decryption key and the portion of the encrypted password can be a length of n/2 or n/2+1 and still be considered half-length.

In another embodiment, the portion of the encrypted decryption key and the portion of the encrypted password in the first combination can be any portion or percentage of the total key size, for example, one third, two third, three fifth, etc. In another embodiment, the encrypted decryption key and the encrypted password can be split at different points. For example, the portion of the encrypted decryption key can be half the length of the encrypted decryption key, while the portion of the encrypted password can be one third of the encrypted password.

Referring to FIG. 2A, for example, the server 105 can combine a portion of encrypted password and a portion of the encrypted decryption key (in BLOCK 245) and generate a first combination 250. The portion of encrypted password and the portion of the encrypted decryption key shown in FIG. 2A are for illustration purposes only. Different lengths of the portions can be used depending on the implementation.

In one embodiment, a second combination of a remaining portion of the encrypted decryption key and a remaining portion of the encrypted password can be generated. For example, the server 105 can be configured to generate a combination which consists of a remaining portion of the encrypted decryption key and a remaining portion of the encrypted password. Referring again to FIG. 2A, the server 105 can combine a remaining portion of encrypted password and a remaining portion of the encrypted decryption key (in BLOCK 245) and generate a second combination 255. The remaining portion of encrypted password and the remaining portion of the encrypted decryption key shown in FIG. 2A are for illustration purposes only.

In one embodiment, after the encrypted password is generated, the encryption key can be discarded. For example, the server 105 can discard the encryption (public) key 210 after the encrypted password 235 is generated. Similarly, in one embodiment, after the encrypted decryption key is generated, the decryption key can be discarded. For example, the server 105 can discard the unencrypted decryption (private) key 215 after the encrypted decryption key 240 is generated. In one embodiment, the encrypted decryption key and the encrypted password can be discarded after the first combination and the second combination are generated. For example, the server 105 can discard the encrypted decryption key 240 and the encrypted password 235 after the first combination 250 and the second combination 255 are generated.

In one embodiment, the first combination can be transmitted. For example, the server 105 can be configured to transmit the first combination to the user device 115 via the network 110, and store the first combination on the user side (i.e. not on the system), for example, in a session cookie. In various embodiments, different protocols can be utilized to transmit the first combination, for example, HTTP, HTTPS, Trivial File Transfer Protocol (TFTP), and the like. In one embodiment, the first combination can be stored in the user session at the user device 115. For example, the first combination can be stored in a cookie at the user device 115. For example, as shown in FIG. 2A, the first combination 250 can be stored in user session 260 at the user device 115.

In one embodiment, the second combination can be temporarily stored in a database. For example, the server 105 can be configured to temporarily store the second combination in a database. In one embodiment, a database can be stored on a memory device or a storage medium of the server 105. For example, the server 105 can write the second combination to a file and save the file in a memory device, such as a RAM, or in a storage medium, such as a hard disk. In one embodiment, the database may be on a separate storage device external to the server 105, for example, the database 120 when it is an external database to the server 105. In some embodiments, a database may be explicitly created using a database language application programming interface (API) call, for example, a Structured Query Language (SQL) API call. The database can be created in-memory (e.g., RAM) or on-disk (e.g., hard disk) or a combination of in-memory and on-disk on the server 105. Referring to FIG. 2A, the second combination 255 can be stored in a database 265.

In some embodiments, information about how the portions of the encrypted password and the portions of the encryption decryption key are determined can be stored. This information can be used to restore the encrypted password and the encryption decryption key from the first combination and the second combination, as described later in the disclosure. The information can be stored together with the first combination and/or the second combination, or can be stored separately from them, for example on the server 105, database 120, or in the user session of the user device 115.

In one embodiment, a request to access sensitive information via the network can be received. For example, the server 105 can be configured to receive a request to access the sensitive information from the user device 115 via the network 110. The request to access sensitive information may include requests to read sensitive information, to update sensitive information, to grant access to sensitive information, for example. In one embodiment, the sensitive information can be stored, for example, in the database 120. For instance, the user device 105 can make a HTTPS request (or using other protocols, such as HTTP) to access the sensitive information after the user is logged into the system at the server 105.

FIG. 2B is a block diagram depicting an example of a password secured retrieval and decryption process. Referring to FIG. 1 and FIG. 2B, in some embodiments, the first combination of a portion of the encrypted decryption key and a portion of the encrypted password can be received. For example, the server 105 can be configured to receive the first combination from the user device 115 via the network 110. In one embodiment, the first combination can be received together with the request to access sensitive information from the user device 115. For example, the first combination can be received with the request in the form of a cookie. In another embodiment, the server 105 can retrieve a cookie that stores the first combination from the user device 115. As illustrate in FIG. 2B, the first combination 250 can be received from the user session 260 (at the user device 115).

In one embodiment, the second combination of a remaining portion of the encrypted decryption key and a remaining portion of the encrypted password can be obtained. For example, the server 105 can be configured to obtain the second combination from the database in which the second combination is stored. The database is described previously in this disclosure. As illustrate in FIG. 2B, the second combination 255 can be obtained from the database 265.

In one embodiment, the encrypted password and the encrypted decryption key can be restored based on the first combination and the second combination. For example, the server 105 can be configured to restore the encrypted password and the encrypted decryption key based on the first combination and the second combination. In one embodiment, information about how the encrypted password and the encrypted decryption key can be restored can be obtained. For example, such information can be retrieved from the server 105, the database 120, or the user session 260 if it is stored in these places. Such information may also have been encrypted and may be decrypted to obtain the original information. As illustrate in FIG. 2B, the encrypted password 235 and the encrypted decryption key 240 can be restored based on the first combination 250 and the second combination 255 (in BLOCK 245).

In one embodiment, the decryption key can be obtained by decrypting the encrypted decryption key. For example, the server 105 can be configured to decrypt the encrypted decryption key and obtain the decryption key. In one embodiment, the encrypted decryption key can be decrypted using an application-level symmetric key and a symmetric key decryption algorithm. The application-level symmetric key can be the same key used to encrypt the decryption key as described previously. The symmetric key decryption algorithm can be the same or similar algorithm used to encrypt the decryption key (e.g., the symmetric key encryption algorithm) as described previously, for example, the PBEWITHSHA-1AND256BITAES-CBC-BC algorithm. As shown in FIG. 2A, for example, the decryption (private) key 215 can be obtained by decrypting the encrypted decryption key 240 using the application-level symmetric key 220 and the symmetric key decryption algorithm 270.

In one embodiment, the password can be obtained by decrypting the encrypted password using the decryption key. For example, the server 105 can be configured to decrypt the encrypted password using the decryption key and obtain the password. In one embodiment, the RSA 2048-bit asymmetrical algorithm can be used to decrypt the encrypted password. As illustrate in FIG. 2B, the password 205 can be obtained by decrypting the encrypted password 235 using the decryption (private) key 215 and the RSA 2048-bit asymmetrical algorithm 275.

In one embodiment, sensitive information can be accessed using the password. For example, the server 105 can be configured to access the sensitive information using the password. In one embodiment, the sensitive information can be stored in the database 120. The information accessed by the server 105 can be sent to the user device 115.

In one embodiment, the password can be discarded. For example, the server 105 can be configured to discard the password. In one embodiment, the server 105 may write all zeros to the memory block that stores the password. By erasing password in this manner, the systems and methods described herein may ensure that the password is permanently deleted from the system, thereby unauthorized users may not be able to obtain the password and the sensitive information that requires the password to access.

In some embodiments, the encrypted decryption key, the decryption key, and the encrypted password can be discarded. For example, the server 105 can discard the encrypted decryption key after the decryption is obtained. For example, the server 105 can discard the decrypted key and the encrypted password after the password is obtained.

In one embodiment, a notification to end the user session can be received. For example, the server 105 can receive a notification to end the user session from the user device 115 via the network 110. In various embodiments, the user session can end in various ways. For example, the user session can end when the user actively logs out the system, or when the session times out, or when the browser is closed, or when the user device 115 or the server 105 crashes.

In one embodiment, the first combination can be discarded from the user session. For example, the server 105 can be configured to discard the first combination from the user session. In one embodiment, the server 105 can clear the cookie that stores the first combination.

In one embodiment, the second combination can be discarded from the database. For example, the server 105 can be configured to discard the second combination from the database.

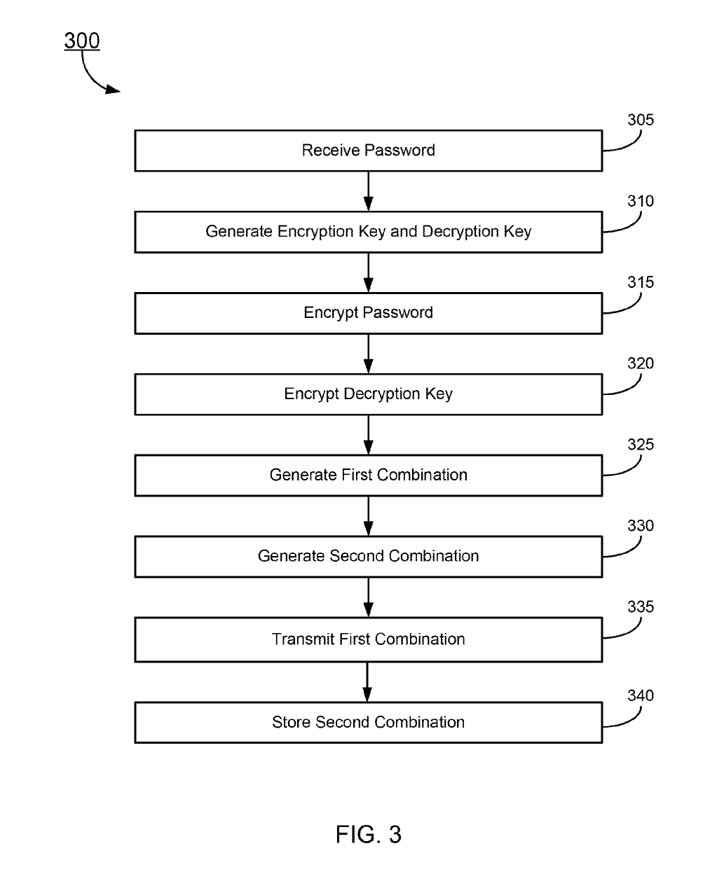

FIG. 3 is a flow diagram illustrating a process according to an exemplary embodiment, such that a password is encrypted and securely stored during a user session. The process 300 can be implemented on a computing device such as server 105 (FIG. 1). In one embodiment, the process 300 may be encoded on a computer-readable medium that contains instructions that, when executed by a computing device, may cause the computing device to perform operations of the process 300.

Process 300 includes receiving a password from a user device via a network (BLOCK 305). For example, a server may receive a password provided by a user at a user device for accessing information stored on the server or a database that the server can access. In some embodiments, a notification to begin a user session can be received at the server. For example, the server may receive the notification to begin a user session when the server receives a HTTPS request from the user device via the network.

Process 300 includes generating an encryption key and a decryption key (BLOCK 310). For example, the server may generate an encryption (public) key and a decryption (private) key using an asymmetric encryption algorithm (e.g., RSA 2048-bit asymmetrical algorithm). In one embodiment, the encryption key and the decryption key can be generated randomly. For example, a Random Number Generators or a Pseudo-Random Number Generators can be used to ensure the composition of the key is random.

Process 300 includes generating an encrypted password by encrypting the password using the encryption key (BLOCK 315). For example, the server may encrypt the password using the encryption (public) key and an asymmetric encryption algorithm (e.g., RSA 2048-bit asymmetrical algorithm). In some embodiments, the password can be discarded after the encrypted password is generated or after a timeout value expires.

Process 300 includes generating an encrypted decryption key by encrypting the decryption key (BLOCK 320). For example, the server may encrypt the decryption (private) key using an application-level symmetric key and a symmetric key encryption algorithm (e.g., the PBEWITHSHA-1AND256BITAES-CBC-BC algorithm).

Process 300 includes generating a first combination of a portion of the encrypted decryption key and a portion of the encrypted password (BLOCK 325). For example, the server may generate a combination which consists of a portion of the encrypted decryption key and a portion of the encrypted password. In one embodiment, the portion of the encrypted decryption key can be of half length of the encrypted decryption key, and the portion of the encrypted password can be of half length of the encrypted password.

Process 300 includes generating a second combination of a remaining portion of the encrypted decryption key and a remaining portion of the encrypted password (BLOCK 330). For example, the server may generate a combination which consists of a remaining portion of the encrypted decryption key and a remaining portion of the encrypted password. In some embodiments, information about how the portions of the encrypted password and the portions of the encryption decryption key are determined can be stored. This information can be used to restore the encrypted password and the encryption decryption key from the first combination and the second combination.

Process 300 includes transmitting the first combination (BLOCK 335). For example, the server may transmit the first combination to the user device via the network, and store the first combination in the user session. In one embodiment, the first combination can be stored in a cookie at the user device.

Process 300 includes storing the second combination in a database (BLOCK 340). For example, the server can store the second combination in a memory device or a storage medium of the server. In one embodiment, the second combination may be stored in a database external to the server. In other embodiments, the second combination can be stored in a database created using a database language API call (e.g., a SQL API call).

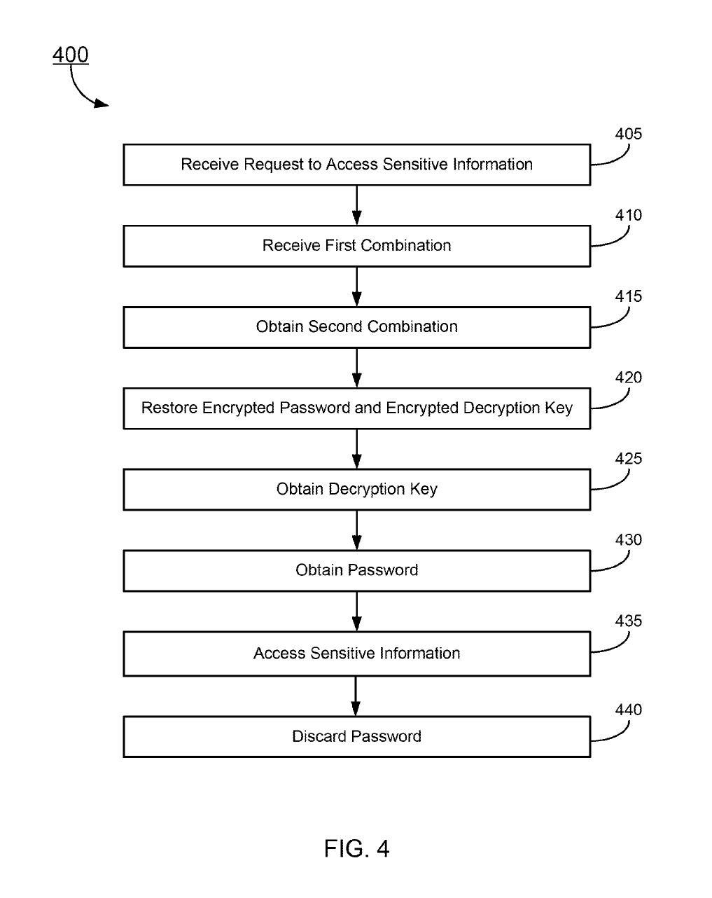

FIG. 4 is a flow diagram illustrating a process according to an exemplary embodiment, such that a password is securely retrieved and decrypted during a user session. The process 400 can be implemented on a computing device such as server 105 (FIG. 1). In one embodiment, the process 400 may be encoded on a computer-readable medium that contains instructions that, when executed by a computing device, may cause the computing device to perform operations of the process 400.

Process 400 includes receiving a request to access sensitive information via the network (BLOCK 405). For example, the server may receive a request from the user device to access sensitive information stored in a database that the server can access.

Process 400 includes receiving the first combination of a portion of the encrypted decryption key and a portion of the encrypted password (BLOCK 410). For example, the server may receive the first combination stored in the user session in the form of a cookie from the user device.

Process 400 includes obtaining the second combination of a remaining portion of the encrypted decryption key and a remaining portion of the encrypted password (BLOCK 415). For example, the server may obtain the second combination from the database in which the second combination is stored.

Process 400 includes restoring the encrypted password and the encrypted decryption key based on the first combination and the second combination (BLOCK 420). For example, the server may restore the encrypted password and the encrypted decryption key according to the information about how to restore the encrypted password and the encrypted decryption key.

Process 400 includes obtaining the decryption (private) key by decrypting the encrypted decryption key (BLOCK 425). For example, the server may decrypt the encrypted decryption key using an application-level symmetric key and a symmetric key decryption algorithm.

Process 400 includes obtaining the password by decrypting the encrypted password using the decryption key (BLOCK 430). For example, the server may decrypt the encrypted password using the decryption (private) key and a decryption algorithm (e.g., the RSA 2048-bit asymmetrical algorithm).

Process 400 includes accessing the sensitive information using the password (BLOCK 435). For example, the server may access the sensitive information stored in a database that the server can access, and return the information to the user device via the network.

Process 400 includes discarding the password (BLOCK 440). For example, the server may discard the password by writing all zeros to the memory block that stores the password.

After various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

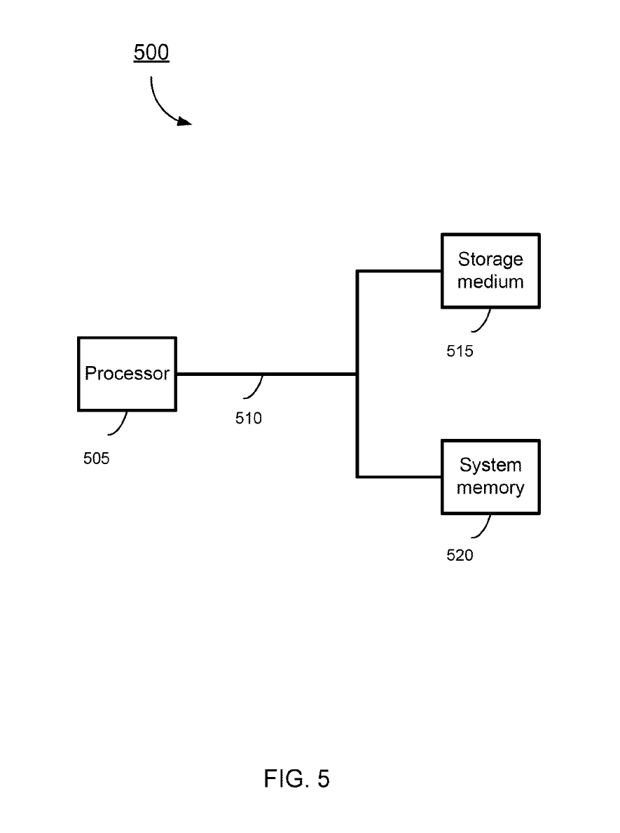

FIG. 5 illustrates a computer system that may be employed to implement systems and methods described and illustrated in the various embodiments herein. The computer system 500 can be used to implement the server 105 and the user device 115. The computer system 500 includes a processor 505 or processing circuit, a system memory 520, and a system bus 510 that couples various system components including the system memory 520 to the processor 505. The system memory 220 may include one or more suitable memory devices such as, but not limited to random access memory (RAM). The computer may include a storage medium 515, such as, but not limited to, a solid state storage device and/or a magnetic hard disk drive (HDD) for reading from and writing to a magnetic hard disk, a magnetic disk drive for reading from or writing to a removable magnetic disk, and an optical disk drive for reading from or writing to removable optical disk such as a CD-RW or other optical media, flash memory, etc. A storage medium 515 may be external to the computer, such as external drive(s), external server(s) containing database(s) or external database(s) such as the database 120, or the like. The drives and their associated computer-readable media may provide non-transitory, non-volatile storage of computer-executable instructions, data structures, program modules, and other data for the computer to function in the manner described herein. Various embodiments employing software embodied on a tangible medium and/or Web implementations can be accomplished with standard programming techniques.

Embodiments of the processes and the operations described herein can be implemented in digital electronic circuitry, or in computer software embodied on a tangible medium, firmware, hardware, or the like. According to various embodiments, computer-executable instructions may encode a process of securely sharing access to information. The instructions may be executable as a standalone, computer-executable program, as multiple programs, or may be executable as a script that is executable by another program, or the like. The instructions stored on a computer readable storage medium can be executable by, or to control the operation of, one or more processors or data processing apparatus.

The above-described embodiments can be implemented using hardware, software or a combination thereof. When implemented in software, the software code can be executed on any suitable processor or collection of processors, whether provided in a single computer system (“computer”) or distributed among multiple computers.

Further, it should be appreciated that a computer may be embodied in any of a number of forms, such as a rack-mounted computer, a desktop computer, a laptop computer, a server computer, a cloud-based computing environment, a tablet computer, etc. Additionally, a computer may be embedded in a device not generally regarded as a computer but with suitable processing capabilities, including a Personal Digital Assistant (PDA), a smart phone, or any other suitable portable or fixed electronic device.

Various embodiments may include hardware devices, as well as program products comprising computer-readable, non-transitory storage media for carrying or having data or data structures stored thereon for carrying out processes as described herein. Such non-transitory media may be any available media that can be accessed by a general-purpose or special-purpose computer or server. By way of example, such non-transitory storage media may comprise random-access memory (RAM), read-only memory (ROM), erasable programmable read-only memory (EPROM), electrically erasable programmable read-only memory (EEPROM), field programmable gate array (FPGA), flash memory, compact disk, or other optical disk storage, magnetic disk storage or other magnetic storage devices, or any other medium which can be used to carry or store desired program code in the form of computer-executable instructions or data structures and which can be accessed by a general-purpose or special-purpose computer. Combinations of the above may also be included within the scope of non-transitory media. Volatile computer memory, non-volatile computer memory, and combinations of volatile and non-volatile computer memory may also be included within the scope of non-transitory storage media. Computer-executable instructions may comprise, for example, instructions and data that cause a general-purpose computer, special-purpose computer, or special-purpose processing device to perform a certain function or group of functions.

In addition to a system, various embodiments are described in the general context of methods and/or processes, which may be implemented in some embodiments by a program product including computer-executable instructions, such as program code. These instructions may be executed by computers in networked environments. The terms “method” and “process” are synonymous unless otherwise noted. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

In some embodiments, the method(s) and/or system(s) discussed throughout may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments may encompass many types of computer system configurations, including personal computers, hand-held devices, multi-processor systems, microprocessor-based or programmable consumer electronics, network personal computers, minicomputers, mainframe computers, and the like.

In some embodiments, the method(s) and/or system(s) discussed throughout may be operated in distributed computing environments in which tasks are performed by local and remote processing devices that may be linked (such as by hardwired links, wireless links, or by a combination of hardwired or wireless links) through a communications network. In a distributed computing environment, according to some embodiments, program modules may be located in both local and remote memory storage devices. Data may be stored either in repositories and synchronized with a central warehouse optimized for queries and/or for reporting, or stored centrally in a database (e.g., dual use database) and/or the like. Databases may include, but are not limited to, highly distributed databases such as those implemented with Apache HBase. Application frameworks that may interface with the database may include, but are not limited to, Ruby on Rails.

The various methods or processes outlined herein may be coded and executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. The computer-executable code may include code from any suitable computer programming or scripting language or may be compiled from any suitable computer-programming language, such as, but not limited to, ActionScript, C, C++, C#, Go, HTML, Java, JavaScript, JavaScript Flash, JSON, Objective-C, Perl, PHP, Python, Ruby, Visual Basic, and XML.

In this respect, various concepts described herein may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments discussed above. The computer-readable medium or media can be transportable, such that the program or programs stored thereon can be loaded onto one or more different computers or other processors to implement various aspects of the present disclosure as discussed above. The recitation of a module, logic, unit, or circuit configured to perform a function includes discrete electronic and/or programmed microprocessor portions configured to carry out the functions. For example, different modules or unit that perform functions may be embodied as portions of memory and/or a microprocessor programmed to perform the functions.

Additionally, it should be appreciated that according to one aspect, one or more computer programs that, when executed, perform methods of the present disclosure, need not reside on a single computer or processor, but may be distributed in a modular fashion amongst a number of different computers or processors to implement various aspects of the present disclosure.

The indefinite articles “a” and “an,” as used herein in the specification and in the claims, unless clearly indicated to the contrary, should be understood to mean “at least one.”

Although the foregoing is described in reference to specific embodiments, it is not intended to be limiting or disclaim subject matter. Rather, the disclosure as described herein is defined by the following claims, and any that may be added through additional applications or other proceedings. The inventors intend no disclaimer or other limitation of rights by the foregoing technical disclosure.

What is claimed is:

1. A computer-implemented method of providing secure access to information during a user session, comprising:
receiving, by one or more processing circuits, a password from a user device via a network;
generating, by the one or more processing circuits, an encryption key and a decryption key;
generating an encrypted password by encrypting the password using the encryption key;
generating an encrypted decryption key by encrypting the decryption key;
generating a first combination of a portion of the encrypted decryption key and a portion of the encrypted password;
generating a second combination of a remaining portion of the encrypted decryption key and a remaining portion of the encrypted password;
transmitting the first combination; and
temporarily storing the second combination in a database.

2. The computer-implemented method of claim 1, further comprising:
receiving a request to access sensitive information via the network;
receiving the first combination of a portion of the encrypted decryption key and a portion of the encrypted password;
obtaining the second combination of a remaining portion of the encrypted decryption key and a remaining portion of the encrypted password;
restoring the encrypted password and the encrypted decryption key based on the first combination and the second combination;
obtaining the decryption key by decrypting the encrypted decryption key;
obtaining the password by decrypting the encrypted password using the decryption key;
accessing the sensitive information using the password; and
discarding the password.

3. The computer-implemented method of claim 1, further comprising:
receiving a notification to begin the user session;
verifying that a hash of the password matches a stored password hash; and
storing the password non-transiently.

4. The computer-implemented method of claim 1, wherein the decryption key is encrypted using an application-level symmetric key and a symmetric key encryption algorithm.

5. The computer-implemented method of claim 1, wherein the portion of the encrypted decryption key is of half length of the encrypted decryption key, and the portion of the encrypted password is of half length of the encrypted password.

6. The computer-implemented method of claim 1, further comprising:
discarding the password;
discarding the encryption key after the encrypted password is generated;
discarding the decryption key after the encrypted decryption key is generated; and
discarding the encrypted decryption key and the encrypted password after the first combination and the second combination are generated.

7. The computer-implemented method of claim 1, further comprising:
receiving a notification to end the user session;
discarding the first combination from the user session; and
discarding the second combination from the database.

8. The computer-implemented method of claim 2, further comprising:
decrypting the encrypted decryption key using an application-level symmetric key and a symmetric key decryption algorithm.

9. The computer-implemented method of claim 2, further comprising:
discarding the encrypted decryption key;
discarding the decryption key; and
discarding the encrypted password.

10. A system of providing secure access to information during a user session, comprising:
memory hardware storing program instructions, and one or more processors in data communication with the memory hardware and configured to execute the program instructions, and upon execution the program instructions causing the one or more processors to perform operations comprising:
receiving a password from a user device via a network;
generating an encryption key and a decryption key;
generating an encrypted password by encrypting the password using the encryption key;
generating an encrypted decryption key by encrypting the decryption key;
generating a first combination of a portion of the encrypted decryption key and a portion of the encrypted password;
generating a second combination of a remaining portion of the encrypted decryption key and a remaining portion of the encrypted password;
transmitting the first combination; and
storing the second combination in a database.

11. The system of claim 10, the operations further comprising:
receiving a request to access sensitive information via the network;
receiving the first combination of a portion of the encrypted decryption key and a portion of the encrypted password;
obtaining the second combination of a remaining portion of the encrypted decryption key and a remaining portion of the encrypted password;
restoring the encrypted password and the encrypted decryption key based on the first combination and the second combination;
obtaining the decryption key by decrypting the encrypted decryption key;
obtaining the password by decrypting the encrypted password using the decryption key;
accessing the sensitive information using the password; and
discarding the password.

12. The system of claim 10, the operations further comprising:
receiving a notification to begin the user session;
verifying that a hash of the password matches a stored password hash; and
storing the password non-transiently.

13. The system of claim 10, wherein the decryption key is encrypted using an application-level symmetric key and a symmetric key encryption algorithm.

14. The computer system of claim 10, wherein the portion of the encrypted decryption key is of half length of the encrypted decryption key, and the portion of the encrypted password is of half length of the encrypted password.

15. The system of claim 10, the operations further comprising:
discarding the password;
discarding the encryption key after the encrypted password is generated;
discarding the decryption key after the encrypted decryption key is generated; and
discarding the encrypted decryption key and the encrypted password after the first combination and the second combination are generated.

16. The system of claim 10, the operations further comprising:
receiving a notification to end the user session;
discarding the first combination from the user session; and
discarding the second combination from the database.

17. The system of claim 11, the operations further comprising:
decrypting the encrypted decryption key using an application-level symmetric key and a symmetric key decryption algorithm.

18. The system of claim 11, the operations further comprising:
discarding the encrypted decryption key;
discarding the decryption key; and
discarding the encrypted password.

19. A non-transitory computer readable medium having machine instructions stored therein, the instructions being executable by one or more processors to cause the one or more processors to perform operations comprising:
receiving a password from a user device via a network;
generating an encryption key and a decryption key;
generating an encrypted password by encrypting the password using the encryption key;
generating an encrypted decryption key by encrypting the decryption key;
generating a first combination of a portion of the encrypted decryption key and a portion of the encrypted password;
generating a second combination of a remaining portion of the encrypted decryption key and a remaining portion of the encrypted password;
transmitting the first combination; and
storing the second combination in a database.

20. The non-transitory computer readable medium of claim 19, the instructions further comprising instructions to cause the one or more processors to perform operations comprising:
receiving a request to access sensitive information via the network;
receiving the first combination of a portion of the encrypted decryption key and a portion of the encrypted password;
obtaining the second combination of a remaining portion of the encrypted decryption key and a remaining portion of the encrypted password;
restoring the encrypted password and the encrypted decryption key based on the first combination and the second combination;
obtaining the decryption key by decrypting the encrypted decryption key;
obtaining the password by decrypting the encrypted password using the decryption key;
accessing the sensitive information using the password; and
discarding the password.

21. The non-transitory computer readable medium of claim 19, the instructions further comprising instructions to cause the one or more processors to perform operations comprising:
receiving a notification to begin the user session;
verifying that a hash of the password matches a stored password hash;
storing the password non-transiently; and
after the password is encrypted using the encryption key, discarding the password.

22. The non-transitory computer readable medium of claim 19, the instructions further comprising instructions to cause the one or more processors to perform operations comprising:
receiving a notification to end the user session;
discarding the first combination from the user session; and
discarding the second combination from the database.
